(19) United States
(12) Patent Application Publication
(10) Pub. No.: US 2012/0132752 A1
(43) Pub. Date: May 31, 2012

(54) INTERFACE ARRANGEMENT BETWEEN TWO COMPONENTS OF AN AIRCRAFT STRUCTURE USING A SEALING PART

(75) Inventors: Ignacio OUTON HERNÁNDEZ, Madrid (ES); José Luis DELGADO JAREÑO, Madrid (ES)

(73) Assignee: AIRBUS OPERATIONS, S.L.

(21) Appl. No.: 13/161,905

(22) Filed: Jun. 16, 2011

(30) Foreign Application Priority Data
Nov. 30, 2010 (ES) 201031768

(51) Int. Cl. B64C 1/38; B23P 17/04

(52) U.S. Cl. 244/130; 29/428

(57) ABSTRACT

Interface arrangement between a first component (11) and a second component (21) of an aircraft structure having an aerodynamic contour, such as a wing skin and a wing leading edge panel, the first component (11) having a joggle so that it includes a first area (13) which surface (15) belongs to the aircraft aerodynamic contour and a second area (17) where the joint with the second component (21) takes place, the second component (21) having a surface (23) belonging to the aircraft aerodynamic contour, in which a sealing part (31) suitable shaped to maintain the continuity of the aircraft aerodynamic contour in the interface area between said components (11, 13) as well as to fill the expected gap (25) between said components (11, 13) is joined to the second component (21).

### FIELD OF THE INVENTION

This invention refers to an interface arrangement between two components of an aircraft structure having an aerodynamic contour and, more in particular, to an interface arrangement for maintaining the continuity of the aerodynamic contour in the interface.

### BACKGROUND OF THE INVENTION

As is well known, weight is a fundamental aspect in the aeronautic industry and therefore there is a current trend to use composite materials instead of metallic materials for aircraft structures with an aerodynamic contour such as lifting surfaces and fuselages.

The composite materials that are most used in the aeronautical industry consist of fibers or fiber bundles embedded in a matrix of thermosetting or thermoplastic resin, as a preimpregnated or “prepreg” material. Their main advantages refer to:

Their high specific strength with respect to metallic materials. It is the strength/weight equation.

Their excellent behavior before fatigue loads.

The possibilities of structural optimization due to the anisotropy of the material and the possibility of combining fibers with different orientations, allowing the design of the elements with different mechanical properties to be adjusted to the different needs in terms of applied loads.

The main structure for aircraft lifting surfaces consists of a leading edge, a torsion box, a trailing edge a root joint and a tip. The torsion box consists of several structural elements: upper and lower skins stiffened by stringers on one side; spars and ribs on the other side. Typically, the structural elements forming the torsion box are manufactured separately and are joined with the aid of complicated tooling to achieve the necessary tolerances, which are given by the aerodynamic, assembly and structural requirements.

The interface between those components whose outer surface belongs to the aircraft aerodynamic contour such as a skin an a leading edge panel in the case of a lifting surface shall be arranged to comply with the aerodynamic requirements in terms of continuity, smoothness and drag, in the interface area.

In the prior art is well known the use of aerodynamic smoothing sealants covered by a paint layer to seal the gaps involved in said interfaces. These sealants are typically uncured pastes suitable for application by extrusion gun or spatula. They can cure at low temperatures and have a good adhesion to common aircraft substrates. However, when the gaps have certain dimensions the application and maintenance of said sealants raise several problems such as cracking, loosening or even detachment. These problems arise more often when the components joined are composite parts because their joints usually involve bigger gaps than metallic interfaces.

This invention is focused on the solution of this problem.

### SUMMARY OF THE INVENTION

One objective of the present invention is to provide a smoother interface arrangement between components of an aircraft structure with an aerodynamic contour that assures the continuity of the aerodynamic contour in that interface area, as well as an easy maintenance, filling the gap associated to the interface.

Another objective of the present invention is to provide an interface arrangement between components of an aircraft structure with an aerodynamic contour that assures the continuity of the aerodynamic contour in the interface area reducing significantly the amount of aerodynamic smoothing sealant applied to seal the gap associated to the interface.

In one aspect these and other objectives are met by an interface arrangement between a first component and a second component of an aircraft structure having an aerodynamic contour, the first component having a joggle so that it includes a first area which surface belongs to the aircraft aerodynamic contour and a second area where the joint with the second component takes place, the second component having a surface belonging to the aircraft aerodynamic contour, in which a sealing part, suitable shaped to maintain the continuity of the aircraft aerodynamic contour in the interface area between said components as well as to fill the expected gap between said components, is joined to the second component.

In a preferred embodiment, said sealing part is made of an elastomeric material. Hereby it is achieved a sealing part able to be prefabricated and easy to install over said second component.

In another preferred embodiment the gap filled with said sealing part has a width W comprised between 10-15 mm and a height H greater than 3 mm. Hereby it is achieved an interface arrangement applicable to many aircraft structures.

In another preferred embodiment said first and second components are composite parts. Hereby it is achieved a suitable smooth aerodynamic interface arrangement of components involving gaps of certain dimensions.

In another preferred embodiment, said sealing part is joined to the second component in a detachable manner so that it can be easily replaced when deteriorated or damaged. Hereby it is achieved a sealing part that can be easily assembled and disassembled on the second component helping the maintenance.

In another preferred embodiment the sealing part comprises a laminar-shaped section to help its join to the second component and a wedge-shaped section to fill said gap, and the second component comprises a joggled area in the joint with the first component to maintain the continuity of the aircraft aerodynamic contour along the whole second component where said sealing part with said laminar-shaped section is joined to the second component. Hereby it is achieved a sealing part that also provides a protection of the edge of the second component in the join area.

In another aspect, the above-mentioned objectives are met by a procedure to carry out the aforementioned joint arrangement comprising steps of: a) join the sealing part to the second component; b) join the second component to the first component. Hereby it is achieved a procedure that helps the assembly of said first and second components.

One particular field of application of the present invention is the interface between a skin and a leading edge panel or a trailing edge panel in an aircraft lifting surface such as a wing or an horizontal tail plane.

Another particular field of application of the present invention is the interface between circumferential sections of an aircraft fuselage.

This invention is applicable to interfaces between composite parts and also to interfaces between metallic parts.

Other characteristics and advantages of the present invention will be clear from the following detailed description of embodiments illustrative of its object in relation to the attached figures.

### BRIEF DESCRIPTION OF DRAWINGS

FIG. 1 is a section side view of an interface arrangement between a wing skin and a wing leading edge panel showing a gap between their aerodynamic surfaces.

FIG. 2 is a section side view of an interface arrangement between a wing skin and a wing leading edge panel comprising a sealing part according to a first embodiment of this invention.

FIG. 3 is a section side view of an interface arrangement between a wing skin and a wing leading edge panel comprising a sealing part according to a second embodiment of this invention.

### DETAILED DESCRIPTION OF THE INVENTION

A detailed description of the invention for an interface arrangement between a wing skin and a wing leading edge panel follows.

The main structure for aircraft lifting surfaces consists of a leading edge, a torsion box, a trailing edge, a root joint and a tip. A torsion box structurally consists of spars, ribs and upper and lower skins with several stringers. The upper and lower skins are joined to the leading edge and the trailing edge panels forming the upper and lower wing aerodynamic contour.

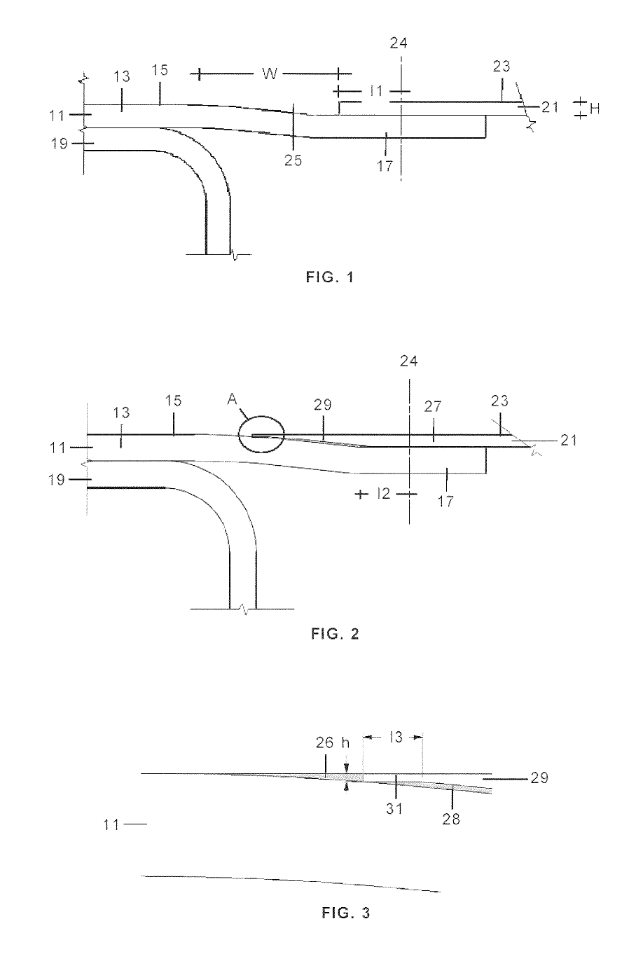

FIG. 1 shows the typical interface arrangement between a wing skin 11 which extends forward the front spar 19 and a wing leading edge panel 21. The wing skin 11 is joggled so that the surface 15 of the first area 13 belongs to the wing aerodynamic contour and the second area 17 is the area where the joint with the leading edge panel 21 is carried out by means of, usually, at least one row of fasteners placed in the position indicated by the line 24. The surface 23 of the leading edge panel 21 also belongs to the wing aerodynamic contour.

This interface arrangement creates a gap 25 of width W and height H which can not be sealed satisfactorily using an aerodynamic smoothing sealant when H is bigger than 10 mm. On the other hand, said sealant raise several maintenance problems due to certain defects (particularly cracking) or to its detachment from the wing skin 11.

According to the present invention, the gap 25 is filled with a sealing part 31 (see FIG. 2) installed on the leading edge panel 21 by any suitable detachable means 39.

The sealing part 31, which in a preferred embodiment is made of an elastomeric material, can therefore be dismounted when needed and replaced by a new sealing part 31 facilitating thus its maintenance.

The sealing part 31 is made with a suitable shape for filling the gap 25 (whose shape is determined by the geometric features of the wing skin 11 in the intermediate zone between said first and second areas 13, 17) taking into account the tolerance margins in the assembly of the leading edge panel 21 with the wing skin 11. It is therefore possible to have several sets of sealing parts 31 for different tolerance and manufacture margins to choose the right one in the assembly line.

In a preferred embodiment, the gap 25 filled with said sealing part 31 has a width W comprised between 10-15 mm and a height H greater than 3 mm.

In the preferred embodiment shown in FIG. 3, the sealing part 31 comprises a laminar-shaped section 33 and a wedge-shaped section 35 and the leading edge panel 21 comprise a joggle of a similar height H1 to the thickness of the laminar-shaped section 33 with a joggled area 27 where the union with the wing skin 11 is carried out. The sealing part 31 is installed on that joggled area 27 at the laminar-shaped section 33 by any suitable detachable means such as bonding means or mechanical means. The aerodynamic contour continuity is maintained in this area by said laminar-shaped section 33.

The sealing part 31 according to this embodiment fills the gap 25 and provides an additional protection to the edge of the leading edge panel 21 against strikes or impacts; if they occur it is the sealing part 31 and not the leading edge panel 21 the part to be repaired.

The procedure to carry out the joint arrangement of the present invention comprises a first step where the sealant part 31 is joined to the leading edge panel 21 previously to the step of joining the leading edge panel 21 to the wing skin 11. Their assembly is therefore facilitated when compared with a joint arrangement using an aerodynamic smoothing sealant.

Although the present invention has been fully described in connection with preferred embodiments, it is evident that modifications may be introduced within the scope thereof, not considering this as limited by these embodiments, but by the contents of the following claims.

1. Interface arrangement between a first component (11) and a second component (21) of an aircraft structure having an aerodynamic contour, the first component (11) having a joggle so that it includes a first area (13) which surface (15) belongs to the aircraft aerodynamic contour and a second area (17) where the joint with the second component (21) takes place, the second component (21) having a surface (23) belonging to the aircraft aerodynamic contour, characterized in that a sealing part (31) suitable shaped to maintain the continuity of the aircraft aerodynamic contour in the interface area between said components (11, 13) as well as to fill the expected gap (25) between said components (11, 13) is joined to the second component (21).

2. Interface arrangement according to claim 1, wherein said sealing part (31) is made of an elastomeric material.

3. Interface arrangement according to claim 1, wherein the gap (25) filled with said sealing part (31) has a width W comprised between 10-15 mm and a height H greater than 3 mm.

4. Interface arrangement according to claim 1, wherein said first and second components (11, 21) are composite parts.

5. Interface arrangement according to claim 1, wherein said first and second components (11, 21) are metallic parts.

6. Interface arrangement according to claim 1, wherein said sealing part (31) is joined to the second component (21) in a detachable manner so that it can be replaced when deteriorated or damaged.

7. Interface arrangement according to claim 6, wherein:
the sealing part (31) comprises a laminar-shaped section (33) to help its join to the second component (21) and a wedge-shaped section (35) to fill said gap (25);
the second component (21) comprises a joggled area (27) in the joint with the first component (11) to maintain the continuity of the aircraft aerodynamic contour along the whole second component (21) where said sealing part (31) with said laminar-shaped section (33) is joined to the second component (21).

8. Interface arrangement according to claim 1, wherein said aircraft structure is a lifting surface.

9. Interface arrangement according to claim 8, wherein said first component (11) is a skin and said second component (21) is a leading edge panel.

10. Interface arrangement according to claim 8, wherein said first component (11) is a skin and said second component (21) is a trailing edge panel.

11. Interface arrangement according to claim 1, wherein said aircraft structure is a fuselage.

12. Interface arrangement according to claim 11, wherein said first and second components (11, 21) are skin circumferential sections.

13. Procedure to carry out an interface arrangement according to claim 1, characterized by comprising steps of:
a) join the sealing part (31) to the second component (21);
b) join the second component (21) to the first component (11).
